(19) United States
(12) Patent Application Publication
(10) Pub. No.: US 2004/0149145 A1
(43) Pub. Date: Aug. 5, 2004

(54) Seafood storage apparatus and method of use

(75) Inventor: James Harris, Yarmouth, ME (US)

Correspondence Address: WEINGARTEN, SCHURGIN, GAGNEBIN & LEBOVICI LLP, TEN POST OFFICE SQUARE, BOSTON, MA, 02109, US

(73) Assignee: Marine Environments

(21) Appl. No.: 10/752,217

(22) Filed: Jan. 6, 2004

Related U.S. Application Data
(60) Provisional application No. 60/438,746, filed on Jan. 8, 2003.

(51) Int. Cl. A01J 15/14

(52) U.S. Cl. 99/467

(57) ABSTRACT

A live seafood storage apparatus having a tank for holding seafood, such as lobsters, and a substantially rectangular storage tank for a large quantity of bacteria-supporting bio-media. The storage tank is disposed beneath the lobster tank. Normally, water drains from the lobster tank into the storage tank, where it passes through a pre-filter and down through the large volume of bio-media. Water is moved from the storage tank back to the lobster tank by a pump. If a power failure occurs, substantially all of the water drains from the lobster tank by gravity into the storage tank. Closed access doors minimize evaporation, thus providing sufficient moisture within the lobster tank for lobsters to survive for an extended period of time.

### CROSS REFERENCE TO RELATED APPLICATIONS

This application claims priority of U.S. Provisional Patent Application No. 60/438,746, filed Jan. 8, 2003, the disclosure of which is incorporated herein by reference.

### STATEMENT REGARDING FEDERALLY SPONSORED RESEARCH OR DEVELOPMENT

N/A

### BACKGROUND OF THE INVENTION

Holding tanks for live seafood such as lobsters have well-known requirements. These include the cycling of water through a two-stage filter to trap particulate waste and for chemical filtration of dissolved organic compounds. It is also known to employ a skimmer in order to remove organic matter which appears as foam.

A further consideration in these environments is the elimination of ammonia and nitrites which are natural byproducts in enclosed aquatic environments. It is known to employ the so-called “nitrogen cycle” to bio-chemically convert ammonia and nitrite into harmless nitrates. In particular, Marineland Laboratories of Moorpark, Calif. offers a line of aquaria that employ a cylinder of biological media which foster and support the growth of beneficial bacteria on its surface. Water is cycled across its surface as the cylinder rotates about its longitudinal axis. The total surface area available for supporting ammonia-oxidizing bacteria is limited, however.

A further concern to owners and operators of tanks for holding lobsters is a power failure. With current lobster tank designs, the loss of power results in the cessation of water re-circulation. Eventually all of the available oxygen is consumed by the lobsters and they effectively “drown” in the oxygen-depleted water.

It would therefore be desirable to have an aquatic storage tank which provides for enhanced ammonia and nitrite processing and which safeguards against the loss of expensive lobster stocks in the event of extended power loss.

### BRIEF SUMMARY OF THE INVENTION

The present invention provides a substantially rectangular storage tank for a large quantity of bacteria-supporting biological media (“bio-media”). The storage tank is disposed beneath the lobster tank. Normally, water drains from the lobster tank into the storage tank, where it passes through a pre-filter and down through the large volume of bio-media. At the bottom of the storage tank, water is removed by a pump and after further processing is returned to the lobster tank. Through the use of the large volume of bio-media, enhanced ammonia and nitrite processing results.

If a power failure occurs, water drains from the lobster tank by gravity into the storage tank. Because of its large dimensions, there is sufficient room in the storage tank to drain substantially all of the water from the lobster tank. Because lids or access doors are typically kept in a closed position on top of the lobster tank, evaporation is minimized and sufficient moisture remains within the lobster tank for the lobsters to survive for an extended period of time.

Additional feature of the presently disclosed invention are discussed below.

### BRIEF DESCRIPTION OF THE SEVERAL VIEWS OF THE DRAWING

FIG. 1A illustrates a side view of the system of the present invention under normal operation conditions.

FIG. 1B illustrates the system of FIG. 1A subsequent to a power loss.

### DETAILED DESCRIPTION OF THE INVENTION

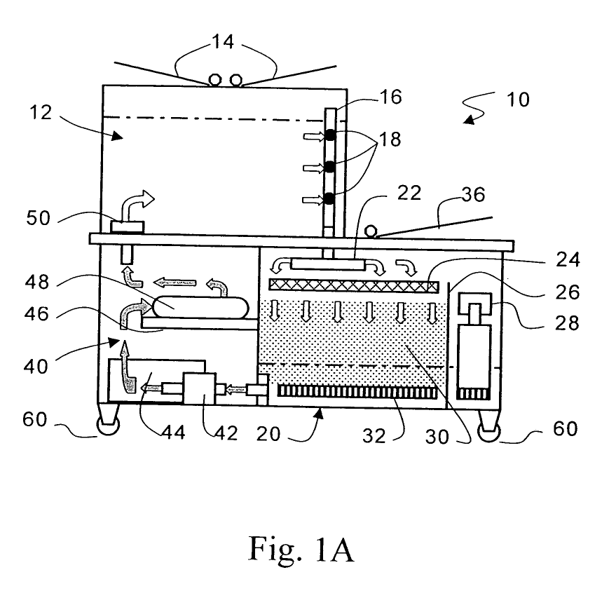

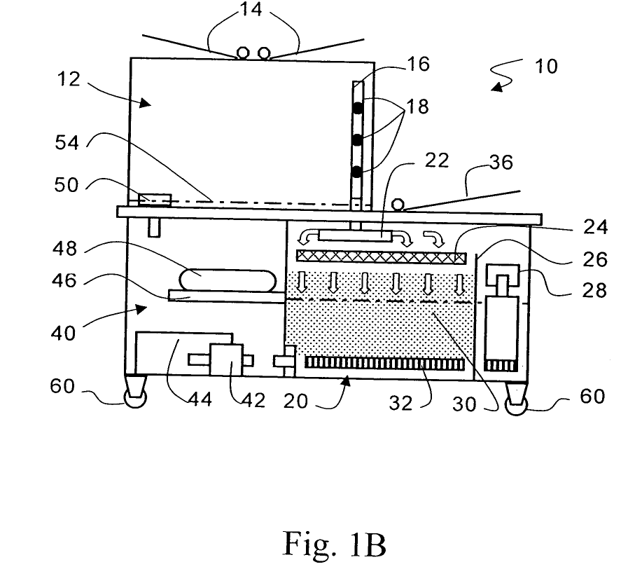

The system 10 of the presently disclosed invention is shown in FIGS. 1A and 1B. In the illustrations, conduits or tubing for conducting water through the system 10 are shown as shaded arrows. Water not conducted by such conduits is represented by non-shaded arrows. The lobster tank 12 itself may be manufactured of any suitable material, including plastic or glass. One or more hinged access lids 14 are also preferably provided.

At least one drain pipe 16 is provided for removing water and waste particulate from the lobster tank 12. The drain pipe 16 is provided with a plurality of drain holes 18 to enable the removal of floating matter such as foam, as well as to enable the complete draining of the lobster tank in the event of power loss (described further below). Thus, while three holes 18 are shown in the drain pipe 16 of FIGS. 1A and 1B, they are merely representative of one configuration. Preferably, a larger number of holes are provided, each of a diameter sufficient to allow for the flow of foam and other particulate matter. In a first embodiment, the lobster tank is twenty inches deep, thirty-six inches long, and twenty-four inches wide.

The drain pipe 16 is in fluid communication with a storage tank 20 disposed below the level of the lobster tank 12. Most of the water entering the storage tank 20 passes through a pre-filter 24, which in a first embodiment is a sheet of conventional pre-filter material such as an activated carbon coated pad having dimensions of twenty-four inches square by two inches deep. This pre-filter 24 removes particulate waste from the drained water. Water may enter the storage tank 20 through a series of horizontally disposed pipes 22 or other conduits in order to more evenly distribute the water over the surface of the pre-filter 24. Preferably, the horizontally disposed pipes form an array of mutually parallel pipes, each having a plurality of perforations and each being in fluid communication with the drain pipe 16. Some of the water entering the storage tank passes a plenum 26 and is subject to a skimmer 28 for the removal of organic matter in the form of foam.

Below the pre-filter 24 is a large volume of bio-media 30, such as so-called “bio-balls,” plastic spheres each having a discontinuous surface and providing a large effective surface area for supporting ammonia-oxidizing and nitrite-oxidizing bacteria. In one embodiment, the storage tank 20 is of sufficient size to contain thirty gallons of bio-balls. The bio-balls 30 are physically supported by a substrate 32 such as perforated plastic. A hinged lid 36 is provided for maintenance purposes.

Water from the storage tank 20 is drained by a pump 42 located in a mechanical cabinet 40 next to the storage tank 20. Depending upon the environment, a chiller 44 may be used for thermal conditioning of the re-circulated water. A shelf 46 is preferably provided within the mechanical cabinet 40 for supporting an ultraviolet (UV) filter 48. While optional, the UV filter 48 is employed to kill undesired, free-swimming bacteria and algae spores. Whether or not UV filtration is employed, water is next pumped back into the lobster tank 12. The port 50 through which water is returned to the lobster tank 12 may be provided with a simple, one-way mechanical valve. An access door with optional venting (not shown) is also provided on one or more sides of the mechanical cabinet 40.

As known to one skilled in the art, grounded power cabling is provided to the electrical systems. A facility for connecting to a water supply may also be provided, preferably for introducing the external water into the top of the storage tank 20 so that external water is subject to the filtration cycle before entering the lobster tank 12. Casters 60 are also provided for ease in relocating the system 10.

Under normal operating conditions, as depicted in FIG. 1A, the majority of the system water is located in the lobster tank 12. Here, the water level is represented by a dashed line. A comparatively smaller amount of water is shown being processed through the pre-filter 24, skimmer 28, and bio-media 30 and is collected in the bottom of the storage tank 20 (see dashed line) prior to being pumped back into the lobster tank 12. The water levels shown in the lobster tank 12 and storage tank 20 are for purposes of illustration only; the actual levels may vary depending upon a variety of factors including the number of lobsters in the lobster tank 12.

In the case of power failure, the majority of the system water drains from the lobster tank 12, through the pipes 22, and into the storage tank 20 under the force of gravity. Note the elevated water level in the storage tank 20, represented by the dashed line, under these conditions. While in the foregoing it was suggested that drain holes 18 were provided along the entire length of the drain pipe(s) 16, it will be apparent that providing the lowest drain hole 18 some distance from the bottom of the lobster tank 12 will enable a small quantity of water 54 to remain in the lobster tank 12. While the hinged lids 14, when closed, serve to maintain the humidity within the now nearly-drained lobster tank 12, an additional thin layer of water 54 at the bottom of this tank will tend to contribute to the humidity, thus prolonging the length of time the lobsters can remain alive without their lungs drying out and becoming unable to process gaseous oxygen.

The system of the illustrations is not necessarily to scale. Further, the location of the various components may be varied depending upon the application. The illustrated system 10, however, is preferred in that ample access to the pre-filter 24, skimmer 28, and bio-media 30 storage area is provided.

What is claimed is:

1. A seafood storage apparatus, comprising:
a first tank adapted for storing live seafood and a variable quantity of liquid;
a second tank adapted for retaining biological media and a variable quantity of liquid;
at least one conduit for enabling liquid to flow from the first tank to the second tank by force of gravity; and
a pump and associated piping for moving liquid from the second tank to the first tank,
wherein the second tank is dimensioned to receive substantially all of the liquid from the first tank through the at least one conduit with the pump not operating.

2. The apparatus of claim 1, wherein the first tank comprises a rectangular enclosure having an open top and a hinged cover enabling selective closure of the open top.

3. The apparatus of claim 1, wherein the at least one conduit comprises a substantially vertical drain pipe disposed within the first tank, the drain pipe having a plurality of vertically distributed perforations for enabling liquid to drain therethrough.

4. The apparatus of claim 3, wherein the at least one conduit further comprises a plurality of horizontally disposed pipes in an upper region of the second storage tank, each of the plurality of horizontally disposed pipes having a plurality of perforations for enabling liquid to drain therethrough, each of the horizontally disposed pipes being in fluid communication with the drain pipe.

5. The apparatus of claim 4, wherein the plurality of horizontally disposed pipes are mutually parallel.

6. The apparatus of claim 1, wherein the second tank comprises a pre-filter through which liquid from the at least one conduit passes.

7. The apparatus of claim 1, wherein the biological media are disposed on biologically inert three-dimensional forms, and wherein substantially all of the liquid flowing from the first tank and through the second tank flows through the biological media.

8. The apparatus of claim 7, wherein the second tank further comprises a biologically inert substrate for supporting the biological media above a bottom surface of the second tank.

9. The apparatus of claim 1, wherein the second tank further comprises a substantially vertical plenum and a skimmer for removing solids floating on an upper surface of the liquid within the second tank, the skimmer and the biological media being separated from each other by the plenum.

10. The apparatus of claim 1, further comprising a chiller in fluid communication with the pump for altering the temperature of the fluid flowing therethrough.

11. The apparatus of claim 1, further comprising an ultraviolet filter in fluid communication with the pump for exposing pumped fluid to ultraviolet radiation.

12. The apparatus of claim 1, further comprising a one-way fluid valve connecting the pump and associated piping to the first tank, whereby fluid only flows into the first tank.

13. A system for storing live lobsters, comprising:
a storage tank having an upper end;
biological media disposed within the storage tank and occupying over half the internal volume thereof;
dispersion piping disposed at the upper end of the storage tank for dispersing liquid across an upper surface of the biological media;
a lobster tank having a bottom surface at the same height as or higher than the upper end of the storage tank;
a drain in the bottom surface of the lobster tank and connected to the dispersion piping for enabling liquid to flow from the lobster tank into the storage tank by force of gravity; and
a pump and piping for conveying liquid from the storage tank to the lobster tank.

14. The system of claim 13, further comprising a plenum vertically disposed within the storage tank and a skimmer for removal of solids floating on an upper surface of a liquid within the storage tank, the skimmer being separated from the biological media by the plenum.

15. The system of claim 13, further comprising a pre-filter disposed within the upper end of the storage tank, substantially beneath the dispersion piping, whereby substantially all of the liquid entering the storage tank through the dispersion piping passes through the pre-filter.

16. The system of claim 15, wherein the pre-filter is an activated carbon coated fiber pad.

17. The system of claim 13, further comprising a chiller for altering the temperature of liquid acted upon by the pump.

18. The system of claim 13, further comprising an ultraviolet filter for providing ultraviolet illumination to the liquid acted upon by the pump.

19. The system of claim 13, further comprising a one-way valve between the lobster tank and the pump and piping for enabling fluid to flow only into the lobster tank through the valve.

20. The system of claim 13, wherein the storage tank is dimensioned to accommodate substantially all of the liquid from the lobster tank when the pump is not pumping liquid from the storage tank into the lobster tank.

21. The system of claim 13, further comprising a substantially vertical drain tube disposed on the drain within the lobster tank, the drain tube having a plurality of vertically spaced drain holes for enabling liquid to be drained from the lobster tank and into the storage tank through the drain tube, the drain, and the dispersion piping under the force of gravity.
